(19) United States
(12) Patent Application Publication
(10) Pub. No.: US 2017/0321944 A1
(43) Pub. Date: Nov. 9, 2017

(54) ICE EXTRACTION DEVICE

(71) Applicant: Beyond Zero, Inc., Louisville, KY (US)

(72) Inventors: Jason S. SHERMAN, Louisville, KY (US); D. Paul HAVILAND, Louisville, KY (US)

(21) Appl. No.: 15/585,660

(22) Filed: May 3, 2017

Related U.S. Application Data
(60) Provisional application No. 62/331,195, filed on May 3, 2016.

(51) Int. Cl. F25C 5/04; F25C 1/04; F25C 5/08

(52) U.S. Cl. CPC F25C 5/04; F25C 5/08; F25C 1/04; F25C 2600/04

(57) ABSTRACT

A device for extraction of a frozen liquid is provided including a tray having a first surface defining at least one cavity and a second surface opposite the first surface. A rod including a protrusion is positioned proximate the at least one cavity. The protrusion passes through the at least one cavity to extract the frozen liquid in response to rotation of the rod.

### CROSS-REFERENCE TO RELATED APPLICATION

This application is related to and claims priority to U.S. Provisional Application Ser. No. 62/331,195, filed May 3, 2016, entitled Ice Extraction Assembly, the entirety of which is incorporated herein by reference.

### TECHNICAL FIELD

The present invention relates to a device for ice extraction, and in particular, a device for the extraction of frozen alcohol or adulterated water.

### BACKGROUND

Traditional ice makers are widespread in today's society as a convenient way to produce ice. Introducing liquids other than water into an ice maker presents a number of issues. For example, when liquids containing an alcohol, a sugar, and/or other adulterated materials are contained with a tray, such as a metal mold, the liquids tend to become adhesives at low temperature, thereby making removal of such “ice cubes” a substantial burden on the power of ice maker motors. In addition, it is very likely that any attempt to extract numerous ice cubes from the metal mold at the same time, especially when made from sugary liquids, would stick together and jam the chute.

Liquids other than water and non-sugary liquids containing an adulterated ingredient may also create problems for typical ice makers as non-sugary liquids may also become adhesives at low temperatures and/or require relatively high heat for removal from the metal mold. Moreover, ice cubes made from adulterated liquids typically stick to coatings, such as hydrophobic and/or icephobic coatings, applied to trays and designed to reduce sticking, thereby rendering these coatings substantially useless.

### SUMMARY

A device for extraction of a frozen liquid is provided including a tray having a first surface defining at least one cavity and a second surface opposite the first surface. A rod including a protrusion is positioned proximate the at least one cavity. The protrusion passes through the at least one cavity to extract the frozen liquid in response to rotation of the rod.

In another aspect of this embodiment, the device includes a heating element in thermal communication with the tray.

In another aspect of this embodiment, the device includes a processing circuitry in electrical communication with the heating element. The processing circuitry includes a processor and a memory, the memory containing instructions that, when executed by the processor, configure the processor to activate the heating element to heat at least a portion of the tray.

In another aspect of this embodiment, the memory contains further instructions that, when executed by the processor, configure the processor to determine a temperature of the tray, the heating element being activated in response to the processor determining the tray meets a liquid freezing temperature threshold.

In another aspect of this embodiment, the tray includes a second cavity, and the rod includes a second protrusion staggered with respect to the protrusion, the second protrusion passing through the second cavity to extract the frozen liquid in response to rotation of the rod.

In another aspect of this embodiment, the device includes a sensor capable of determining a presence of at least one of an alcohol and a sugar in the frozen liquid.

In another aspect of this embodiment, the device includes a wiping member coupled to the rod and a torque sensor in communication with the rod and the wiping member.

In another embodiment, the device for extraction of a frozen liquid includes a tray having a first surface defining a plurality of cavities and a rod positioned proximate the plurality of cavities. The rod includes a first protrusion and a second protrusion extending therefrom, the first protrusion staggered with respect to the second protrusion. A motor is in communication with the rod. The first protrusion and the second protrusion pass through a respective cavity of the plurality of cavities to extract the frozen liquid in response to rotation of the rod by the motor.

In another aspect of this embodiment, the rod includes at least one end having a plurality of teeth, and the motor is mechanically coupled to the plurality of teeth.

In another aspect of this embodiment, the device includes a bar positioned proximate the plurality of cavities and a distance from the rod, the distance being less than a length of the first protrusion and the second protrusion.

In another aspect of this embodiment, the device includes a sensor capable of determining a presence of at least one of an alcohol and a sugar in the frozen liquid.

In another aspect of this embodiment, the first protrusion is staggered at an acute angle with respect to the second protrusion.

In another aspect of this embodiment, the rod includes a third protrusion and a fourth protrusion, the third protrusion being staggered with respect to the fourth protrusion. The third protrusion and the fourth protrusion pass through a respective cavity of the plurality of cavities to extract the frozen liquid in response to rotation of the rod.

In another aspect of this embodiment, the first protrusion has substantially a same alignment with respect to the rod as the fourth protrusion, and the second protrusion has substantially the same alignment with respect to the rod as the third protrusion.

In another aspect of this embodiment, the second protrusion and the third protrusion pass through the plurality of cavities before the first protrusion and the fourth protrusions in response to rotation of the rod.

In another aspect of this embodiment, the rod includes a midpoint, and the second protrusion and the third protrusion are each positioned closer to the midpoint of the rod when compared to a position of the first protrusion and the fourth protrusion relative to the midpoint.

In another aspect of this embodiment, the rod defines a rod axis extending across the plurality of cavities, and the first protrusion and the second protrusion are sloped at an angle with respect to the rod axis.

In another aspect of this embodiment, the device includes at least one heating element in thermal communication with the tray.

In another aspect of this embodiment, the device includes a wiping member coupled to the rod and a torque sensor in communication with the rod and the wiping member.

In another embodiment, the device for extraction of a frozen liquid includes a tray having a first surface defining a plurality of cavities and a second surface opposite the first surface. A heating element is in thermal communication with the second surface of the tray. A rod is positioned proximate the plurality of cavities. The rod defines a rod axis extending across the plurality of cavities. The rod includes a first protrusion and a second protrusion sloped at an angle with respect to the rod axis, the first protrusion staggered with respect to the second protrusion. The rod also includes a third protrusion and a fourth protrusion sloped at an angle with respect to the rod axis, the third protrusion staggered with respect to the fourth protrusion and having substantially a same alignment with respect to the second protrusion. The rod further includes a midpoint, the second protrusion and the third protrusion being positioned closer to the midpoint when compared to a position of the first protrusion and the fourth protrusion relative to the midpoint. A motor is in communication with the rod, the first protrusion, the second protrusion, the third protrusion, and the fourth protrusion each passing through a respective cavity of the plurality of cavities to extract the frozen liquid in response to rotation of the rod by the motor. A wiping member is coupled to the rod and a torque sensor in communication with the rod and the wiping member.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary device for performing frozen liquid extraction in accordance with the principles of the invention;

FIG. 2 is a top plan view of one embodiment of a tray including a first surface in accordance with the principles of the invention;

FIG. 3 is a perspective view of one embodiment of the tray of FIG. 2 in accordance with the principles of the invention;

FIG. 4 is a bottom plan view of one embodiment of the tray of FIG. 2 including a second surface in accordance with the principles of the invention;

FIG. 5 is perspective view of one embodiment of the tray of FIG. 2 in accordance with the principles of the invention;

FIG. 6 is a block diagram of a bottom plan view of one embodiment of the tray of FIG. 2 in accordance with the principles of the invention;

FIG. 7 is a flow diagram of an exemplary heating process in accordance with the principles of the invention;

FIG. 8 is a top plan view of one embodiment of a rod in accordance with the principles of the invention;

FIG. 9 is a bottom plan view of the rod of FIG. 8 in accordance with the principles of the invention;

FIG. 10 is a front view of the rod of FIG. 8 in accordance with the principles of the invention;

FIG. 11 is an isometric view of the rod of FIG. 8 in accordance with the principles of the invention;

FIG. 12 is an elevational left-side view of rod of the FIG. 8 in accordance with the principles of the invention;

FIG. 13 is an elevational right-side view of the rod of FIG. 8 in accordance with the principles of the invention;

FIG. 14 is top plan view of the tray of FIG. 2 and the rod of FIG. 8 in accordance with the principles of the invention;

FIG. 15 is a flow diagram of one embodiment of a rotation process in accordance with the principles of the invention; and

FIG. 16 is a flow diagram of an extraction process for extracting frozen liquid in accordance with the principles of the invention.

### DETAILED DESCRIPTION

Before describing in detail exemplary embodiments that are in accordance with the disclosure, it is noted that the embodiments reside primarily in combinations of device components and processing steps related to frozen alcohol or adulterated water, i.e., not pure water, liquid extraction. Accordingly, components have been represented where appropriate by conventional symbols in drawings, showing only those specific details that are pertinent to understanding the embodiments of the disclosure so as not to obscure the disclosure with details that will be readily apparent to those of ordinary skill in the art having the benefit of the description herein.

As used herein, relational terms, such as “first,” “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

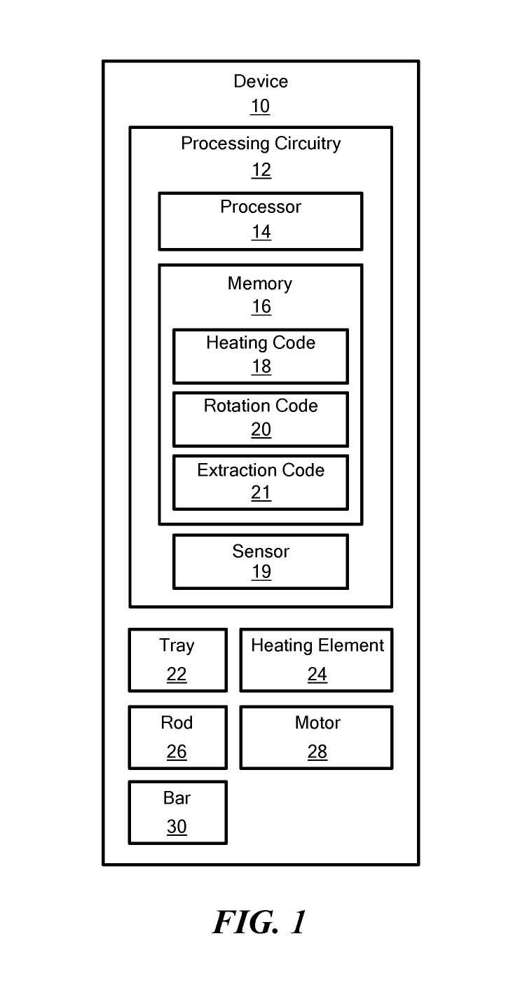

Referring now to drawing figures in which like reference designators refer to like elements there is shown in FIG. 1 an exemplary a device 10 for performing frozen liquid extraction in accordance with the principles of the invention. The terms “liquid” and “frozen liquid” include a liquid containing an alcohol, such as liquor, beer, wine, or other spirits, a sugar, and/or other adulterated materials. Upon extraction, the frozen liquid is intended to be consumed as a beverage. Accordingly, the device 10 may be installed within an assembly or machine commonly found in a venue or establishment where beverages, such as alcoholic beverages, are served.

As shown in FIG. 1, the device 10 includes a processing circuitry 12 having a processor 14 and a memory 16. In addition to a traditional processor and memory, the processing circuitry 12 may comprise integrated circuitry for processing and/or controlling, e.g., one or more processors and/or processor cores and/or FPGAs (Field Programmable Gate Array) and/or ASICs (Application Specific Integrated Circuitry). The processor 14 may be configured to access (e.g., write to and/or reading from) the memory 16, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). The memory 16 may be configured to store code executable by the processor 14 and/or other data.

The processing circuitry 12 may be configured to control any of the methods and/or processes described herein and/or to cause such methods and/or processes to be performed, e.g., by the device 10. Corresponding instructions may be stored in the memory 16, which may be readable and/or readably connected to the processor 14. As discussed in further detail herein, the memory 16 is configured to store one or more codes, such as a heating code 18, a rotation code 20, and/or an extraction code 21. The codes include instructions that, when executed by the processor 14, cause the processor 14 to perform the processes associated with each code. The code executed by the processor may be dependent upon the type of liquid to be extracted. In order to determine the type of liquid, the device 10 may include at least one sensor 19 in communication with the processing circuitry 12 which determines the type of liquid based on one or more properties of the liquid, such as the connectivity of the liquid.

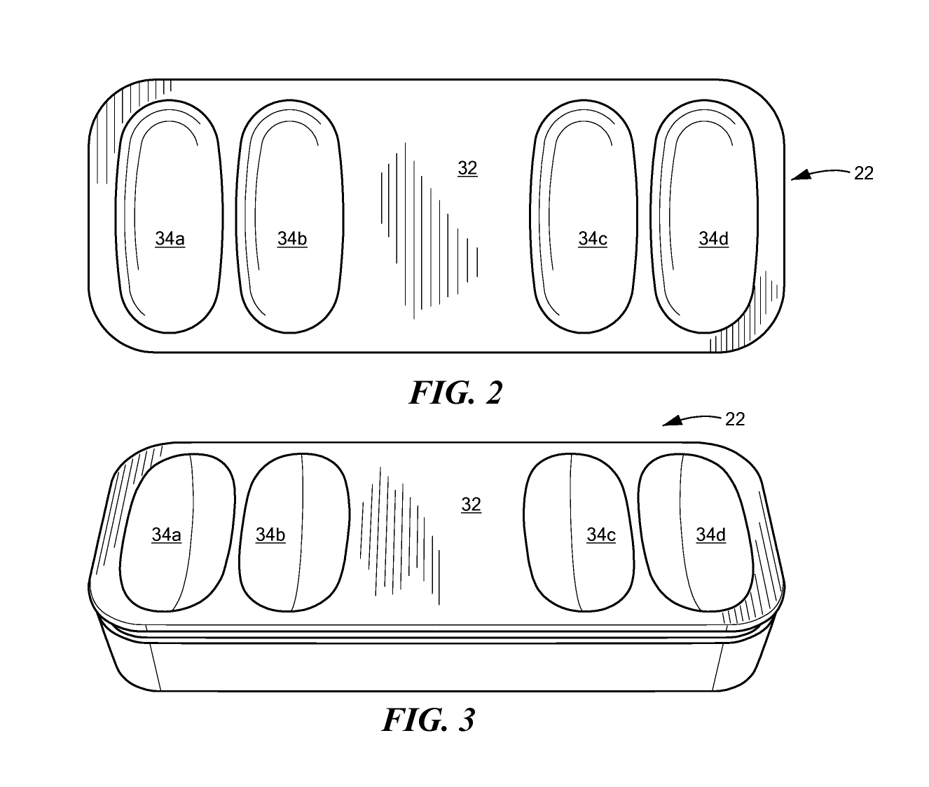

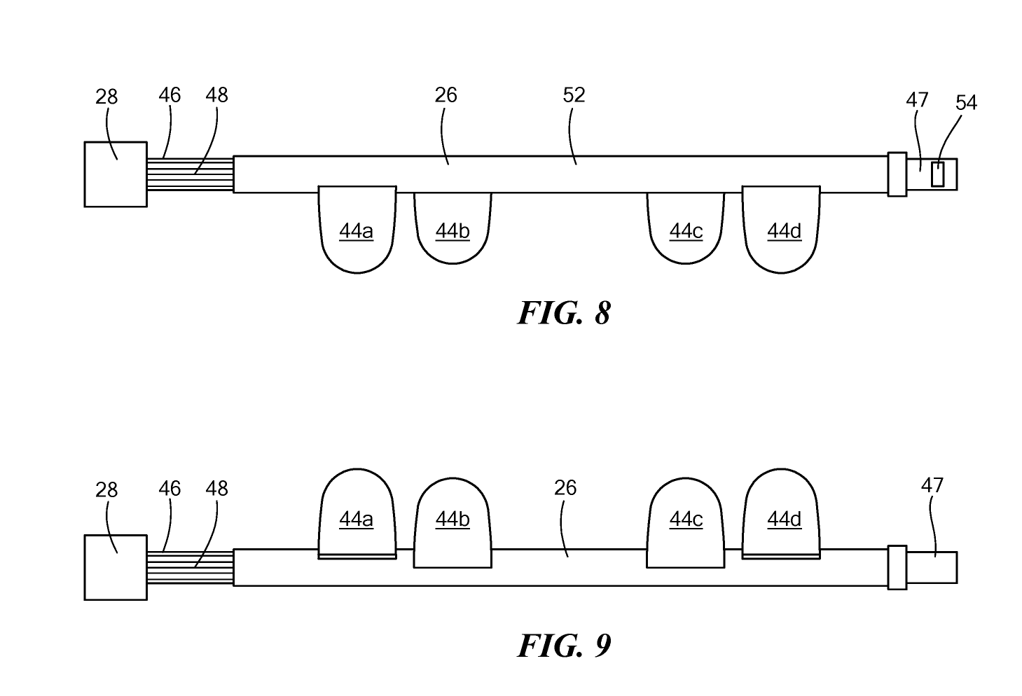

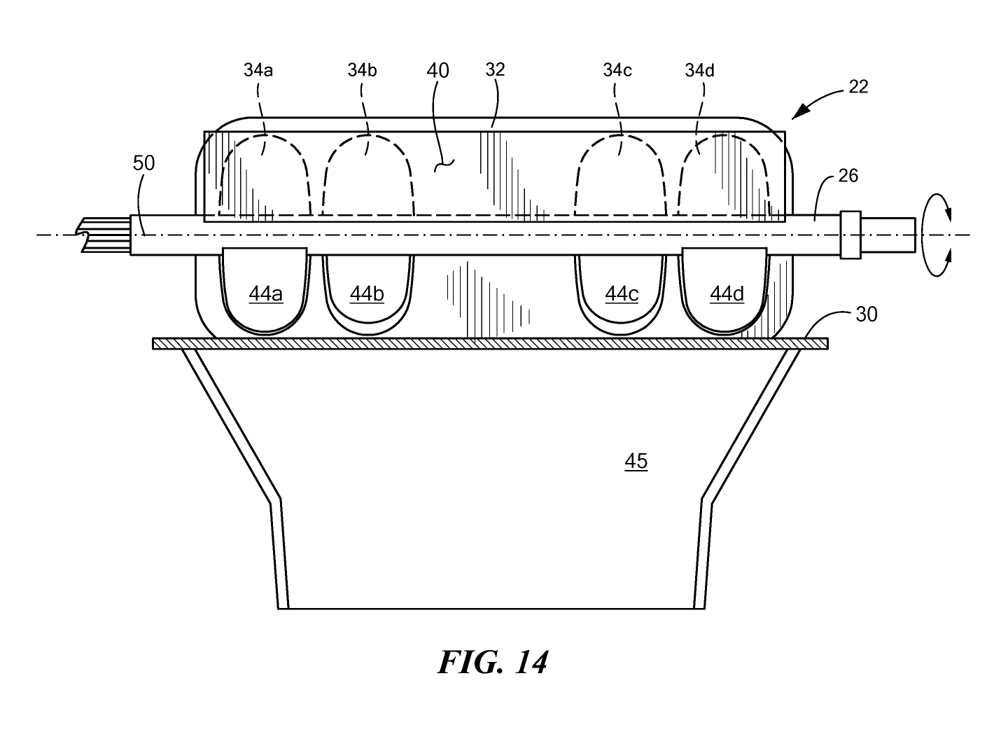

In an exemplary configuration of the device, the device 10 may include a tray 22 for freezing the liquid and a heating element 24 in thermal communication with the tray 22 and in electrical communication with the circuitry 12. A rod 26 having a protrusion 44 (as illustrated in FIG. 8) extending therefrom may be positioned proximate the tray 22. In use, during rotation of the rod 26 by a motor 28 or another actuator, the protrusion 44 passes through a cavity 34 (as illustrated in FIG. 2) of the tray 22 to perform extraction of the frozen liquid from the tray 22 through a mechanical force, as discussed in detail below. A bar 30 may be positioned proximate the tray 22 to obstruct the frozen liquid if the frozen liquid is adhering to the rod 26 and the rod 26 is rotating, as discussed in detail with respect to FIG. 14.

With reference to FIG. 2, a top plan view of the tray 22 is depicted having a first surface 32 defining one or more cavities 34a-34d, which may be collectively referred to as a cavity 34. The tray 22 may be a block or a mold composed of one or more materials, such as metal, aluminum, or the like, used to freeze the liquid when disposed within the cavity 34. While the cavity 34 is illustrated in FIG. 2 as having an oval shape and/or form defined by the first surface 32, other shapes and/or forms are equally applicable to the cavity 34. FIG. 3 is a perspective view of one embodiment of the tray 22 depicting the first surface 32 defining the cavity 34.

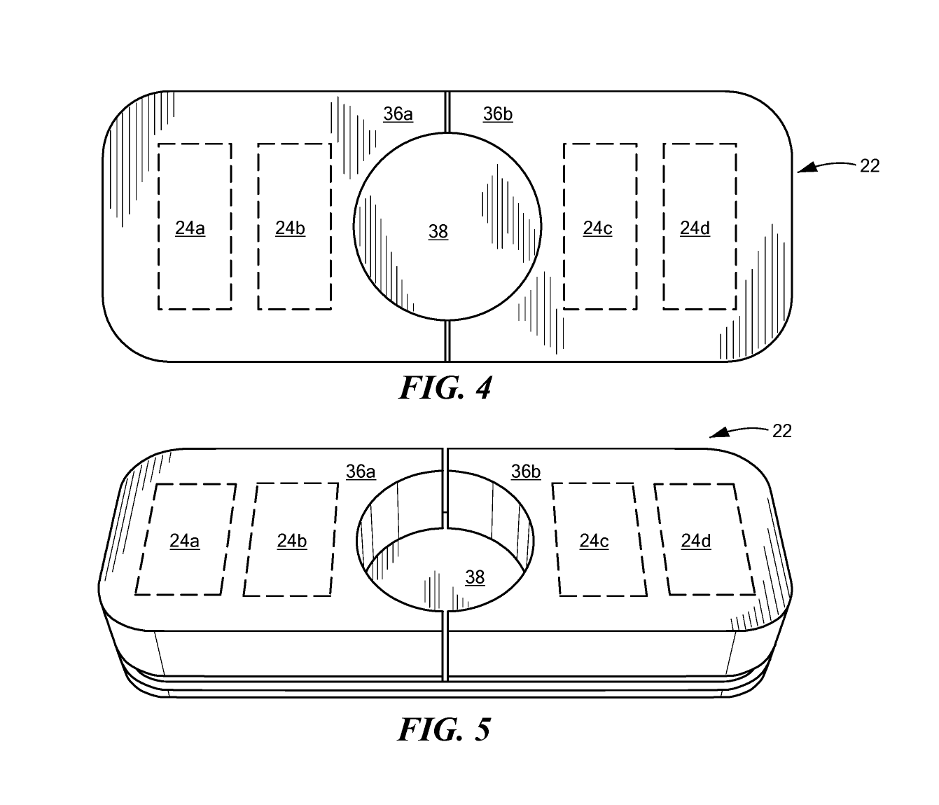

FIG. 4 is a bottom plan view of the tray 22 including a second surface 36, opposite the first surface 32 (as illustrated in FIG. 2). With brief reference to FIG. 5, in conjunction with FIG. 4, the second surface 36 may be separated, e.g., by a line of demarcation, to form a set of second surfaces 36a and 36b. The tray 22 includes a receptacle 38 for receiving a freezing element (not shown) to thermally cool the tray 22 and freeze the liquid when disposed within the cavity 34.

In contrast to the freezing element, the tray 22 may also be exposed to the heating element 24. The heating element 24 may utilize power, such as power ranging from five to twenty-five watts at twenty-four volts, to heat select portions of the tray 22. In one exemplary embodiment, the cavities 34a-34d may be individually exposed to the heating element 24. As a result, the heating element 24 heats the frozen liquid when disposed within the cavity 34 so as to loosen the frozen liquid for extraction. The activation of the heating element 24 does not affect the overall freezing temperature of the tray 22 and/or the time lapse until the next freezing cycle.

The heating element 24 may be directly or indirectly coupled to the tray 22, such as to the second surface 36 of the tray 22. In one exemplary configuration, the heating element 24 is selectively positioned relative to a portion of the tray 22, such as the cavity 34, where the thickness of the tray 22 between the first surface 32 and the second surface 36 is thinner than a remaining thickness of the tray 22. When disposed at such a location, the heating element 24 heats a small concentrated area of the tray 22 at the thinnest portion of the crucible to melt only the outermost surface layer of the frozen liquid disposed within the cavity 34. In this manner, the frozen liquid may be loosened for extraction without melting all of the liquid within the cavity 34.

The ability to selectively isolate and heat specific portions of the tray 22 advantageously reduces the amount of energy that would otherwise be required to heat the entire tray. The specific portions of the tray 22 heated by the heating element 24 display an increase in temperature by delta (Δ), as measured from the temperature of the frozen liquid. Delta(Δ) ranges from 20-200 degrees Fahrenheit. As a further advantage, heating only select portions of the tray 22 allows the tray 22 to cool at a faster rate than existing trays, thereby increasing the production of frozen liquid available for extraction. Although the heating elements 24a-24d are described as being as being disposed on the second surface 36 opposite the respective cavities 34a-34d of the first surface 32, other arrangements of the heating elements 24a-24d are within the scope of the present invention. The heating elements 24 may also be omitted based on design implementation.

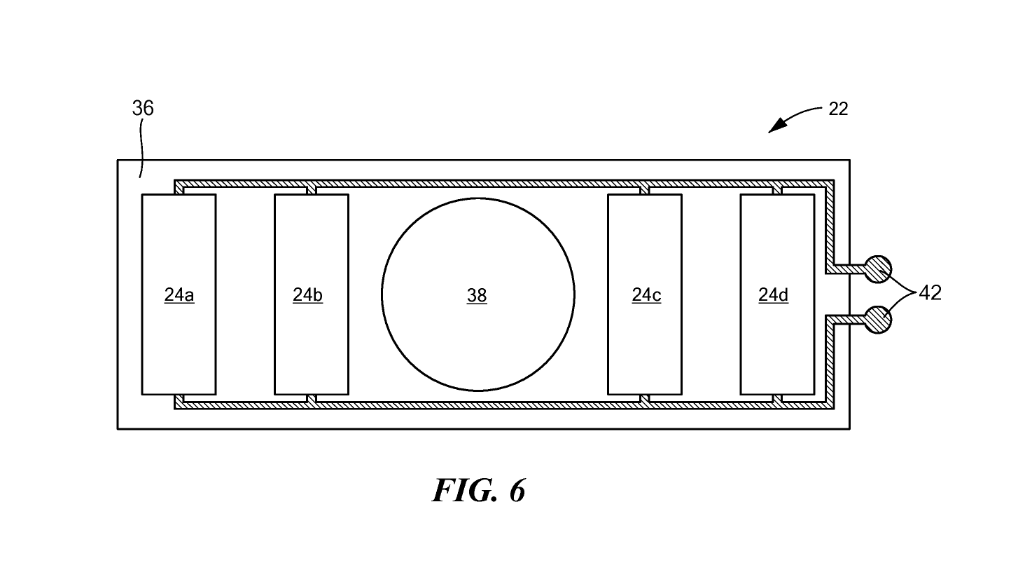

FIG. 6 is a block diagram of a bottom view of the tray 22 and one or more electrical traces 42 in electrical communication with the heating element 24. The electrical traces 42 transmit electrical energy to the heating element 24 to increase the thermal temperature of the tray 22. Although the heating elements 24a-24d are depicted as being disposed parallel with respect to each other, such configuration is not intended to be limiting and the heating elements 24a-24d may also be positioned in series or another combination. A power supply (not shown) may be coupled to the electrical trace 42 to active the heating element 24.

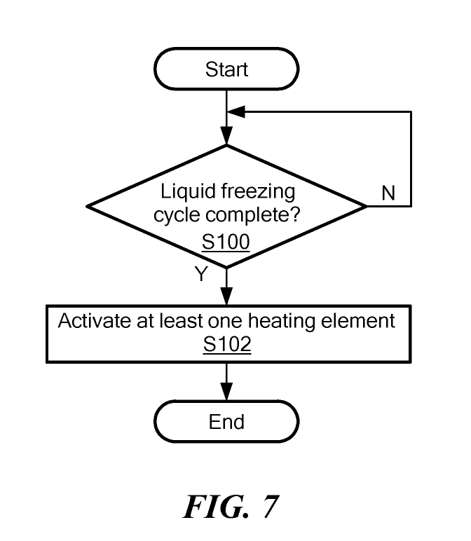

FIG. 7 is a flow diagram of an exemplary heating process of the heating code 18. The heating process begins with the processing circuitry 12 determining whether a liquid freezing cycle is complete (Block S100). More specifically, the processing circuitry 12 determines whether a temperature of the tray 22 meets a predefined threshold, e.g., a liquid freezing threshold, and/or whether the freezing element positioned within the receptacle 38 (as illustrated in FIG. 6) has been active for a predetermined amount of time. The processor 12 is activated using the instructions stored in the memory 16. When the processing circuitry 12 determines that the liquid freezing cycle has completed, the processing circuitry 12 activates at least one of the heating elements 24a-24d (Block S102) for a predefined amount of time or until a predefined heat temperature threshold of the cavities 34a-34d is met.

With reference now to FIG. 8, a top plan view of the rod 26 is depicted including one or more protrusions 44a-44d, which may be collectively referred to as the protrusion 44. With brief reference to FIG. 14, the rod 26 is positioned proximate the first surface 32 of the tray 22 and defines a rod axis 50 extending across the cavities 34a-34d. The protrusions 44a-44d are disposed proximate a respective cavity 34a-34d such that the protrusions 44a-44d enter the cavities 34a-34d during rotation of the rod 26 about the axis 50. The protrusion 44 applies a mechanical force to the frozen liquid when disposed within the cavity 34 to extract the frozen liquid from the cavity 34. Once extracted, the frozen liquid may be ejected in a direction or toward a chute 45, as discussed below.

The protrusion 44 is depicted having a rounded edge in conformity with a shape of the cavity 34, however the protrusion 44 is not limited to any specific shape, length, width and/or thickness so long as the protrusion 44 can enter the cavity 34 during rotation of rod 26. The device 10 is not limited to the number and configuration of protrusions 44 illustrated in FIGS. 8-11, as other configurations and number of protrusions are possible in accordance with the teachings of the invention.

With reference again to FIG. 8, the protrusion 44 may be sloped at an angle, such as an acute angle, with respect to the rod axis 50 to increase the amount of force applied from the protrusion 44 to the frozen liquid during extraction. The slope of the protrusion angle with respect to the rod axis 50 may vary in accordance with the overall design of the device 10. The increase in force advantageously reduces the amount of power needed from the motor 28 to extract the frozen liquid.

In one configuration, the motor 28 may be mechanically coupled to the rod 26 and electrically coupled to the processing circuitry 12. The motor 28 rotates the rod 26, such as when prompted by the processing circuitry 12. Although the distal portion 46 of the rod 26 is depicted including one or more teeth 48 configured to mechanically couple with the motor 28, other coupling arrangements between the rod 26 and the motor 28 may be used.

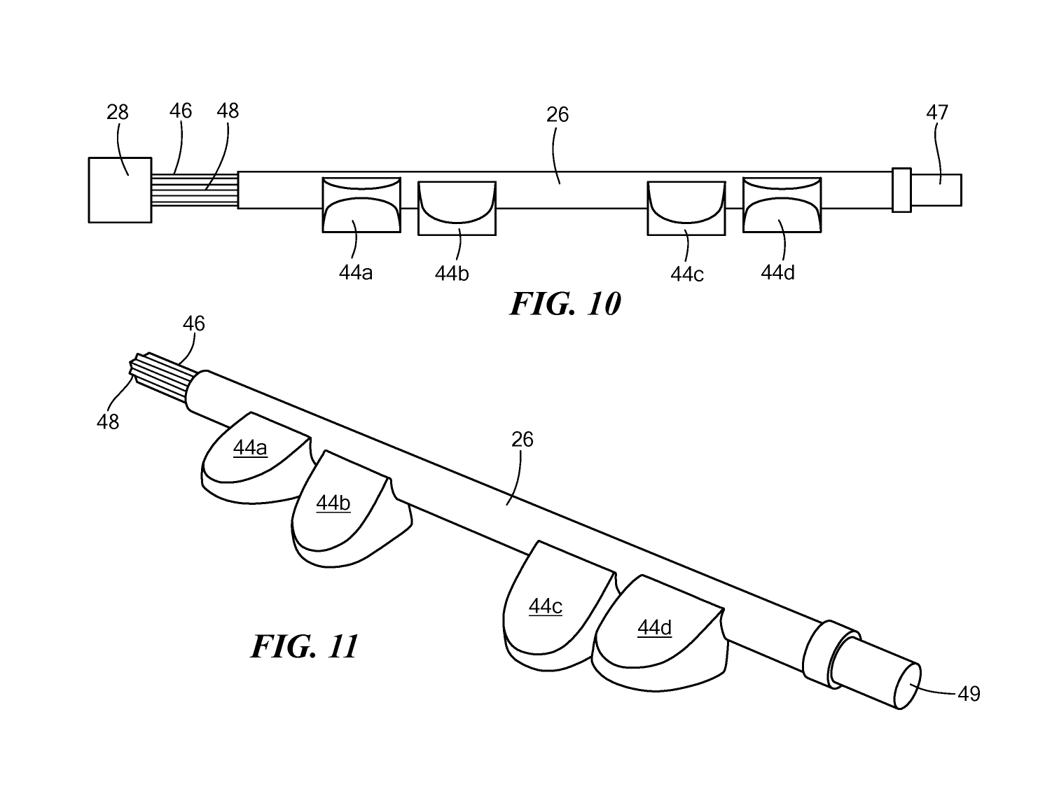

FIGS. 9 and 10 are a bottom view and a front view of the rod 26, respectively, depicting the protrusions 44a-44b positioned in a staggered configuration, e.g., approximately 15 to 20 degrees staggered, with respect to each other. In one exemplary configuration, the protrusion 44a is staggered with respect to the protrusion 44b and the protrusion 44c is staggered with respect to the protrusion 44d. The relative staggering between the protrusions 44 may vary and is not intended to be limited to a specific angle.

The staggered configuration advantageously causes the protrusions 44b, 44c in a midpoint 52 of the rod to engage the frozen liquid in the cavities 34b, 34c prior to the protrusions 44a, 44d so as not to overload the motor 28 when the rod 26 is rotating. More specifically, by staggering one or more of the protrusions 44 with respect to the other protrusions 44, as the rod 26 is rotating, the instant invention applies more rotational torque to at least two select protrusions 44 simultaneously, while reducing the likelihood of motor stalling or motor overcurrent. As a further advantage, staggering the protrusions 44 allows an amount of the extracted frozen liquid entering an exit chute to be controlled, thereby preventing a buildup of frozen liquid in the exit chute. In one example, the frozen liquid in the cavity 34b, 34c may be extracted after the frozen liquid in the cavity 34a, 34d to aid the freezing process.

As depicted in FIGS. 8-11, the protrusions 44a and 44d, i.e., the outer protrusions, are aligned or substantially aligned with each other, while the protrusions 44b and 44c, i.e., the inner protrusions, are aligned or substantially aligned with each other. The term “substantially aligned” is intended to allow approximately 1-5 degrees of deviation between the alignment of the protrusions 44. Such alignment of the protrusions 44 also advantageously assists in allowing maximum torque to be applied to the frozen liquid within two cavities 34 at a time, thereby helping prevent motor overcurrent or motor stalling. Extracting the frozen liquid from the cavities 34a-34d at the same time may cause motor overcurrent or may cause the motor 28 to stall if the frozen liquid adheres to one or more cavities 34a-34d, as typically happens when the frozen liquid contains the alcohol, sugar and/or one or more other adulterated ingredients.

As a further advantage, during rotation of the rod 26, because the outer protrusions enter the respective cavities 34a, 34d after the inner protrusions 44b, 44c, the rod 26 is prevented from deforming during rotation. In addition, because the rod 26 is not prone to deformation, i.e., bending, the rod 26 may be manufactured from materials which are less rigid and costly than materials such as metal.

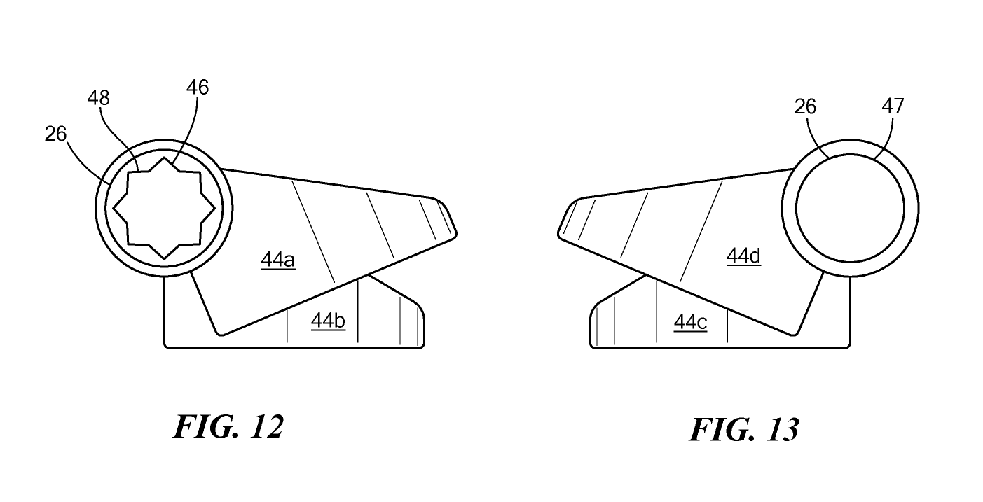

In one exemplary configuration, as depicted in FIG. 11, the proximal portion 47 of the rod 26 may include a bearing 49 for mechanically engaging additional portions of the device 10 and/or an assembly or machine to allow for rotation of the rod 26 around the rod axis 50 through the center of the bearing 49. FIG. 12 depicts a side view of the distal portion 46 of the rod 26, whereas FIG. 13 depicts a side view of the proximal portion 47 of the rod 26.

With reference to FIG. 14, a top plan view of the tray 22 is depicted including the rod 26 and the bar 30 positioned proximate the first surface 32 of the tray 22. The bar 30 may be an elongated rod, stick, or shaft which that is positioned parallel or substantially parallel to the rod 26. The bar 30 may also be positioned a first distance from the rod 26, such as equal to a length of the protrusion 44. In another embodiment, the bar 30 may be positioned relative to the rod 26 such that bar 30 will obstruct the frozen liquid when adhered to the protrusion 44. In other words, when the frozen liquid is temporarily adhered to the protrusion 44 while the rod 26 is rotating, the frozen liquid will collide with the bar 30, thereby detaching the frozen liquid from the protrusion 44. The chute 45 guides the extracted frozen liquid from the cavities 34 to a chute ledge, cliff or ridge from which the frozen liquid will fall.

In an exemplary configuration, the device 10 may include a wiping member 40 coupled to the rod 26, such as on a portion of the rod 26 opposite the protrusion 44. The device 10 may trigger the motor 28 to rotate the rod 26 until the wiping member 40 is in contact with the first surface 32 of the tray 22. The wiping member 40 may be made of a flexible material, such as rubber, configured to transfer, i.e., sweep, the frozen liquid from the first surface 32 of the tray 22 to the chute 45, thereby reducing the occurrence of problems associated with ambient moisture building upon the tray 22. In addition to or in lieu of the wiping member 40, the device 10 may also include an air compressor configured move the remaining frozen liquid from the first surface 32 of the tray to the chute 45 to further combat problems associated with ambient moisture.

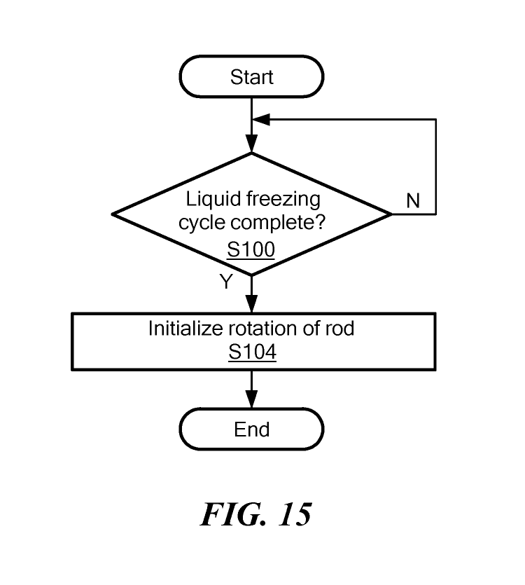

FIG. 15 is a flow diagram of one embodiment of a rotation process of the rotation code 20 in accordance with the principles of the invention. As discussed above (Block S100), the processing circuitry 12 determines whether a liquid freezing cycle is complete. If the processing circuitry 12 determines the liquid freezing cycle has completed, the processing circuitry 12 causes rotation of the rod 26 (Block S102). In one or more configurations, the processing circuitry 12 triggers the motor 28 to rotate the rod 26 for a predetermined number of rotations and/or a predetermined amount of time. The processing circuitry 12 tracks the rotation of the rod 26 by monitoring the motor 28 turns from a predetermined motor position. The position of the rod 26 and the protrusions 44 relative to the cavities 34 may be monitored by the processing circuitry 12.

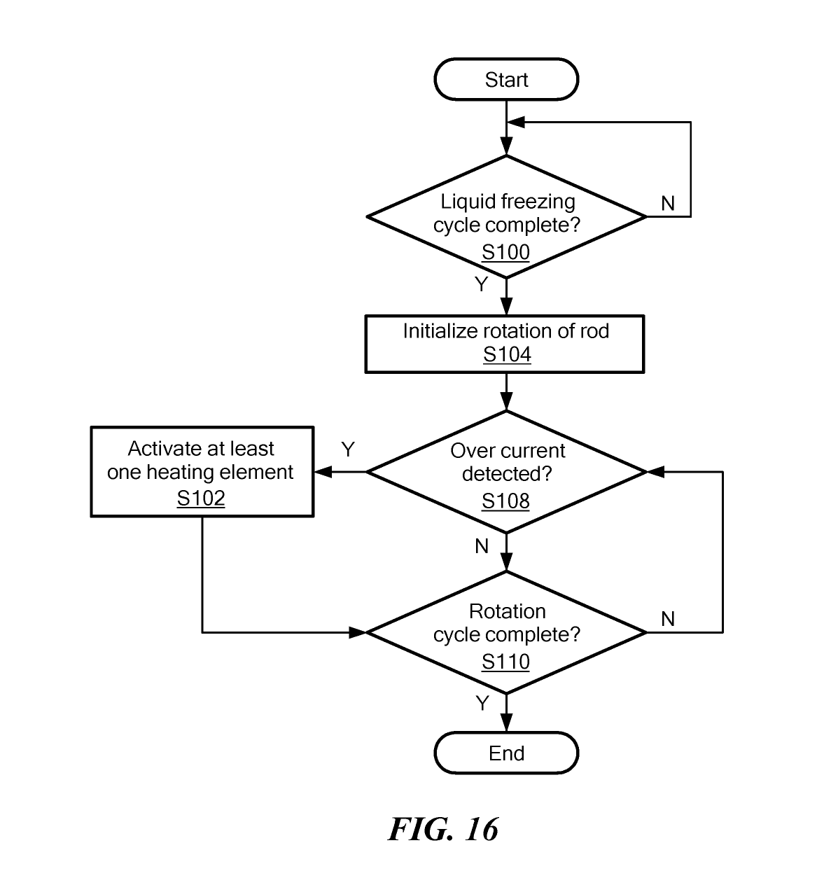

FIG. 16 illustrates a flow diagram of an extraction process of the extraction code 21 for extraction of the frozen liquid. As discussed above, the processing circuitry 12 is configured to determine whether a liquid freezing cycle is complete (Block S100). If the processing circuitry 12 determines the liquid freezing cycle has not completed, the processing circuitry 12 repeats the determination of Block S100. If the processing circuitry 12 determines the liquid freezing cycle has completed, the processing circuitry 12 initializes rotation of the rod 26, i.e., triggers the motor 28 to start rotation of the rod 26 (Block S104). The processing circuitry 12 next determines whether an overcurrent in the motor 28 is detected (Block S108). In particular, an overcurrent in the motor 28 indicates that the rod 26 may be stuck or slowing down, such as when the frozen liquid is adhering to one or more of the cavities 34. The overcurrent detection may be triggered when a current to the motor reaches a predefined amount as indicated by a current sensor in communication with the processing circuitry 12. In other configurations, with brief reference to FIG. 8, overcurrent in the motor 28 is detected using a torque sensor 54 coupled to the rod 26.

With reference still to FIG. 16, if the processing circuitry 12 determines no over current in the motor 28 is detected, the processing circuitry 12 determines whether a rotation cycle of the rod 26 is complete (Block S110). In one or more embodiments, a rotation cycle of the rod 26 causes a three-hundred-and-sixty-degree rotation of the protrusions 44. In other configurations, such as when the wiping member 40 is coupled to the rod 26, the protrusions 44 move in a back and forth motion that is less than the three-hundred-and-sixty-degree rotation. If the processing circuitry 12 determines the rotation cycle of the rod 26 is complete, the extraction process ends as the complete rotation cycle of the rod 26 indicates that the extraction of the frozen liquid within the cavities 34 was completed.

With reference to S108, if the processing circuitry 12 determines over current has been detected, the processing circuitry 12 activates the heating element 24, as discussed above (Block S102). In particular, the heating element 24 is activated to partially melt the frozen liquid that has adhered to the cavity 34 and is thus inhibiting or resisting rotation of the rod 26. In one or more embodiments, the processing circuitry 12 uses information about the position of the protrusions 44 to determine which of the cavities 34 contain the stuck or adhered frozen liquid.

In one illustrative example, using the embodiment of the rod 26 in FIG. 11, over current in the motor 28 may be detected when the processing circuitry 12 determines that the protrusions 44a and 44d are partially through the cavities 34a, 34d but the protrusions 44b, 44c are substantially at the top of the cavities 34b and 34c. In this example, the processing circuitry 12 determines that the frozen liquid in the cavities 34b, 34c is causing the over current in the motor 28. As a result of the frozen liquid adhering to the cavities 34b, 34c when the frozen liquid in the cavities, 34a, 34d has been at least partially moved, the processing circuitry 12 actives the heating elements 24b, 24c while leaving the heating elements 24a, 24d inactive. In one or more configurations, all or other combinations of the heating elements 24 are triggered in response to determining over current in the motor 28.

In an exemplary configuration, if the processing circuitry 12 determines that the rotation cycle is not complete, in addition to activating the heating element 24, the processing circuitry 12 may activate an auto cleaning code which includes instructions that cause the processor 14 to halt rotation of the rod 26 by the motor 28 and implement a cleaning process. The motor 28 may be deactivated for a preprogrammed time interval, such as between 30 to 45 seconds. In another configuration, the auto cleaning code may be activated in lieu of the heating code 18 and the wiping member 40 may be used to transfer any remaining frozen liquid from the first surface 32 of the tray 22 to the chute 45. Thereafter, when no overcurrent is detected, the processing circuitry 12 performs Block S110 which corresponds to the rotation cycle of the rod 26 being complete.

In one or more configurations, the processing circuitry 12 determines whether to implement the heating process of the heating code 18, the rotation process of the rotation code 20 or the extraction process of the extraction code 21, based on the type of liquid to be frozen, such as water, an alcohol, an alcohol including a sugar, etc. As discussed above, the device 10 may include at least one sensor 19 (as illustrated in FIG. 1) in communication with the processing circuitry 12. For example, when the sensor 19 detects that the liquid to be frozen is water, the processing circuitry 12 may perform the heating process as water is unlikely to adhere to the tray 22. In another example, when the sensor 19 detects that the liquid includes an alcohol and a sugar, the processing circuitry 12 may perform the extraction process and/or the heating process, as frozen alcohol with sugar has a higher chance of adhering to the tray 22 than frozen water.

In one configuration, when a predetermined type of liquid is detected, the processing circuitry 12 may perform the rotation process and may determine that heat is not needed. In another example, both the heating process and the rotation process are performed at the same time. More specifically, heat may be applied to the cavity 34 before the protrusion 44 enters the cavity 34, while the protrusion 44 is entering the cavity 34, or while the protrusion 44 is moving through cavity 34, to prevent the frozen liquid in the cavity 34 from adhering thereto. As a result, a less powerful motor can be used than that which would otherwise be needed to rotate the rod 26 and extract the frozen liquid, and over current detection may be omitted.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A device for extraction of a frozen liquid comprising:
a tray including a first surface defining at least one cavity and a second surface opposite the first surface; and
a rod including a protrusion positioned proximate the at least one cavity, the protrusion passing through the at least one cavity to extract the frozen liquid in response to rotation of the rod.

2. The device according to claim 1, further comprising a heating element in thermal communication with the tray.

3. The device according to claim 2, further comprising a processing circuitry in electrical communication with the heating element, the processing circuitry including a processor and a memory, the memory containing instructions that, when executed by the processor, configure the processor to activate the heating element to heat at least a portion of the tray.

4. The device according to claim 3, wherein the memory contains further instructions that, when executed by the processor, configure the processor to determine a temperature of the tray, the heating element being activated in response to the processor determining the tray meets a liquid freezing temperature threshold.

5. The device according to claim 1, wherein the tray includes a second cavity, and the rod includes a second protrusion staggered with respect to the protrusion, the second protrusion passing through the second cavity to extract the frozen liquid in response to rotation of the rod.

6. The device according to claim 1, further comprising a sensor capable of determining a presence of at least one of an alcohol and a sugar in the frozen liquid.

7. The device according to claim 1, further comprising a wiping member coupled to the rod and a torque sensor in communication with the rod and the wiping member.

8. A device for extraction of a frozen liquid comprising:
a tray including a first surface defining a plurality of cavities;
a rod positioned proximate the plurality of cavities, the rod including a first protrusion and a second protrusion extending therefrom, the first protrusion staggered with respect to the second protrusion; and
a motor in communication with the rod, the first protrusion and the second protrusion passing through a respective cavity of the plurality of cavities to extract the frozen liquid in response to rotation of the rod by the motor.

9. The device according to claim 8, wherein the rod includes at least one end having a plurality of teeth, and the motor is mechanically coupled to the plurality of teeth.

10. The device according to claim 8, further comprising a bar positioned proximate the plurality of cavities and a distance from the rod, the distance being less than a length of the first protrusion and the second protrusion.

11. The device according to claim 10, further comprising a sensor capable of determining a presence of at least one of an alcohol and a sugar in the frozen liquid.

12. The device according to claim 8, wherein the first protrusion is staggered at an acute angle with respect to the second protrusion.

13. The device according to claim 8, wherein the rod includes a third protrusion and a fourth protrusion, the third protrusion being staggered with respect to the fourth protrusion, the third protrusion and the fourth protrusion passing through a respective cavity of the plurality of cavities to extract the frozen liquid in response to rotation of the rod.

14. The device according to claim 13, wherein the first protrusion has substantially a same alignment with respect to the rod as the fourth protrusion, and the second protrusion has substantially the same alignment with respect to the rod as the third protrusion.

15. The device according to claim 13, wherein the second protrusion and the third protrusion pass through the plurality of cavities before the first protrusion and the fourth protrusions in response to rotation of the rod.

16. The device according to claim 13, wherein the rod includes a midpoint, and the second protrusion and the third protrusion are each positioned closer to the midpoint of the rod when compared to a position of the first protrusion and the fourth protrusion relative to the midpoint.

17. The device according to claim 8, wherein the rod defines a rod axis extending across the plurality of cavities, and the first protrusion and the second protrusion are sloped at an angle with respect to the rod axis.

18. The device according to claim 8, further comprising at least one heating element in thermal communication with the tray.

19. The device according to claim 8, further comprising a wiping member coupled to the rod and a torque sensor in communication with the rod and the wiping member.

20. A device for extraction of a frozen liquid comprising:
a tray including a first surface defining a plurality of cavities and a second surface opposite the first surface;
a heating element in thermal communication with the second surface of the tray;
a rod positioned proximate the plurality of cavities and defining a rod axis extending across the plurality of cavities, the rod including:
a first protrusion and a second protrusion sloped at an angle with respect to the rod axis, the first protrusion staggered with respect to the second protrusion;
a third protrusion and a fourth protrusion sloped at an angle with respect to the rod axis, the third protrusion staggered with respect to the fourth protrusion and having substantially a same alignment with respect to the second protrusion; and
a midpoint, the second protrusion and the third protrusion being positioned closer to the midpoint when compared to a position of the first protrusion and the fourth protrusion relative to the midpoint;
a motor in communication with the rod, the first protrusion, the second protrusion, the third protrusion, and the fourth protrusion each passing through a respective cavity of the plurality of cavities to extract the frozen liquid in response to rotation of the rod by the motor;
a wiping member coupled to the rod; and
a torque sensor in communication with the rod and the wiping member.
